(19) United States
(12) Patent Application Publication
(10) Pub. No.: US 2026/0025716 A1
(43) Pub. Date: Jan. 22, 2026

(54) HANDOVER LOAD DISTRIBUTION

(71) Applicant: APPLE INC., Cupertino, CA (US)

(72) Inventors: Fangli Xu, Beijing (CN); Haijing Hu, Los Gatos, CA (US); Naveen Kumar R Palle Venkata, San Diego, CA (US); Yuqin Chen, Beijing (CN); Alexander Sirotkin, Hod Hasharon (IL); Ping-Heng Kuo, London (GB); Dawei Zhang, Saratoga, CA (US); Sethuraman Gurumoorthy, San Ramon, CA (US); Ralf Rossbach, Munich (DE)

(21) Appl. No.: 18/997,922

(22) PCT Filed: Aug. 9, 2022
(86) PCT No.: PCT/CN2022/111095

§ 371 Date: Jan. 23, 2025

(51) Int. Cl. H04W 36/00; H04W 36/36

(52) U.S. Cl. CPC H04W 36/0072; H04W 36/037; H04W 36/362

(57) ABSTRACT

The present disclosure relates to Handover load distribution. There provides a wireless device, comprising: at least one antenna; at least one radio coupled to the at least one antenna; and a processor coupled to the at least one radio; wherein the wireless device is configured to: acquire delay configuration information about a Handover to be performed by the wireless device; and perform the Handover based on the information when a Handover execution condition is met.

### TECHNICAL FIELD

This application relates generally to wireless communication, including handover in a wireless communication.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to improved Handover in the wireless communication systems, and particularly relate to Handover load distribution by means of delay time in the wireless communication systems.

According to the techniques described herein, for Handover of wireless devices from a source network device to a target device in a wireless communication system, the Handover of at least some of the wireless devices can be delayed, so that Handovers of respective UEs can be executed at different times. Therefore, the Handovers and thereby Handover loads can be distributed, and the cell congestion due to the group UE handover can be avoided.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3A illustrates exemplary non-terrestrial network.

FIG. 3B illustrates the difference on the RSRP change in the cell center and the cell edge between TN network and NTN network.

FIG. 3C illustrates transitions of UEs as a cell moves completely out of original coverage area.

FIG. 4 illustrates exemplary Handover process according to some embodiments of the present disclosure.

FIG. 5 is a flowchart diagram illustrating an example method at the wireless device side according to some embodiments of the present disclosure.

FIG. 6 is a flowchart diagram illustrating an example method at the network device side according to some embodiments of the present disclosure.

FIGS. 7A and 7B illustrate exemplary diagrams of Handover Framework according to some embodiments of the present disclosure.

FIGS. 8A to 8C are flowchart diagrams illustrating exemplary configuration of Handover delay time by the wireless device according to some embodiments of the present disclosure.

FIGS. 9A to 9B are flowchart diagrams illustrating exemplary configuration of Handover delay time by the network device according to some embodiments of the present disclosure; and

FIGS. 10A to 10D are signaling diagrams illustrating exemplary operation during the Handover delay time or after the Handover delay time according to some embodiments of the present disclosure.

### DETAILED DESCRIPTION

### Terms

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device-any of various types of computer systems or devices that perform wireless communications. A wireless device can be portable (or mobile) or may be stationary or fixed at a certain location. A UE is an example of a wireless device.

Communication Device-any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system. As an example, the base station may be, for example, an eNB in a 4G communication standard, a gNB in a 5G communication standard, a remote radio head, a wireless access point, an unmanned aerial vehicle control tower, or a communication device that performs similar functions.

Network Device-any of various types of computer systems or devices that perform communications, particularly perform wireless communication with the wireless device, such as downlink communication to the wireless device related to downlink transmission. The network device can be portable (or mobile) or may be stationary or fixed at a certain location. A base station is an example of a network device.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

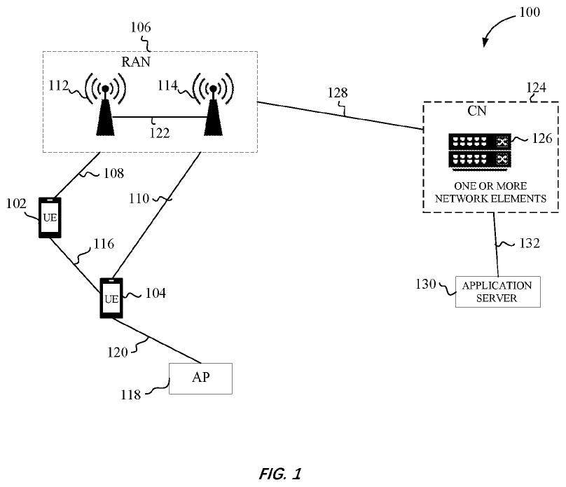

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-FiR router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

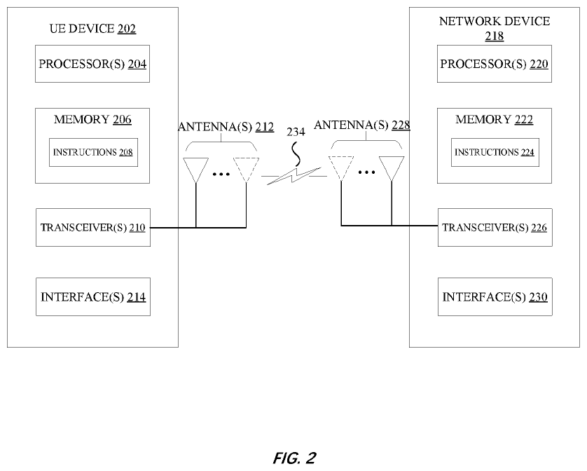

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may be used for various aspects of the present disclosure, particularly configure appropriate delay time for Handover operation and/or performing the Handover operation when the delay time expires. Such operation/functionality can be implemented via hardware, software, or combinations thereof. For example, such operation/functionality can be performed by means of a specific component incorporated in the wireless device, for example, a processor, circuit, which can be integrated within the processor(s) 204 and/or the transceiver(s) 210, and/or can be performed by means of software, such as instructions 208 stored in the memory 206 and executed by the processor(s) 204. In particular, such functionality can be implemented by a combination of software components (e.g., executed by a DSP or a general processor) and hardware components (e.g., logic gates and circuitry) within the processor(s) 204 or the transceiver(s) 210. Some embodiments of such operation/functionality will be described below in detail with reference to figures.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may be used for various aspects of the present disclosure, particularly configure appropriate delay time for Handover operation and/or provides the configured delay time to the wireless devices so that the wireless device can perform the Handover operation when the delay time expires. Such operation/functionality can be implemented via hardware, software, or combinations thereof. For example, such operation/functionality can be performed by means a specific component incorporated in the wireless device, for example, a processor, circuit, which can be integrated within the processor(s) 220 and/or the transceiver(s) 226, and/or can be performed by means of software, such as instructions 224 stored in the memory 222 and executed by the processor(s) 220. In particular, such functionality can be implemented by a combination of software components (e.g., executed by a DSP or a general processor) and hardware components (e.g., logic gates and circuitry) within the processor(s) 220 or the transceiver(s) 226. Some embodiments of such operation/functionality will be described below in detail with reference to figures.

Wireless communication techniques are continually under development, to increase coverage, to better serve the range of demands and use cases, and for a variety of other reasons.

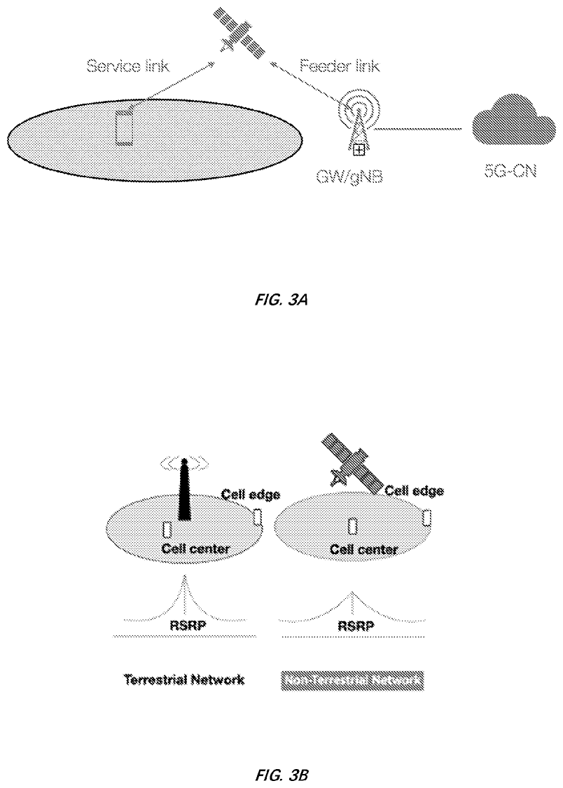

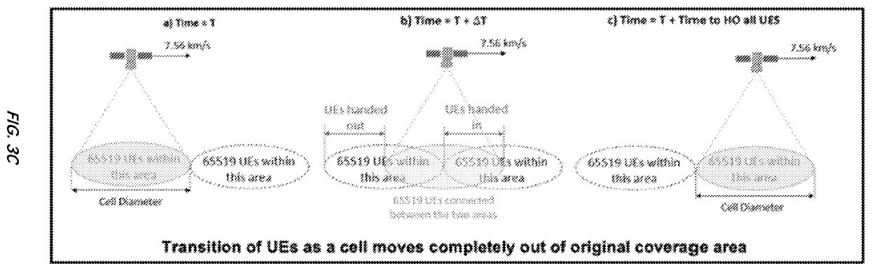

In wireless communication cases, there usually exist a variety of network architectures, particularly Non-Terrestrial Networks (NTN). Non-Terrestrial Networks (NTN) usually refer to networks, or segments of networks which can use an airborne or spaceborne vehicle for communication transmission, and may be so-called space-based networks, where spaceborne vehicles can be a variety of appropriate kinds of spacecrafts or aircrafts running in space according to the laws of celestial mechanics, such as any appropriate kind of satellite, including, but not limited to Low Earth Orbit (LEO), Medium Earth Orbit (MEO), Geosynchronous Earth Orbit (GEO), High Earth Orbit (HEO) satellites, and so on. Airborne vehicles can include a variety of appropriate vehicles at appropriate space height, such as High Altitude Platforms (HAPS), and so on. FIG. 3A illustrates an exemplary NTN network architecture including two parts: a ground part, which includes a gNB and/or GW part to process the data in RAN side, and a satellite, or other airborne, space borne in the air/space, which is transparently forwarding the data between the UE and the gNB, such as by means of a service link and a feeder link.

For Non-Terrestrial Networks, there may exist many usage scenarios in which the Non-Terrestrial Networks can address mobile broadband needs and public safety needs in unserved/underserved areas, and such usage scenarios may include, but not limited to, Maritime, airplane connectivity, railway, and so on.

For Non-Terrestrial Networks, there may usually exist many assumptions. More specifically, it is usually assumed that a NR NTN, especially LEO and GEO, has implicit compatibility to support HAPS and ATG (Air-To-Ground) scenarios. In particular, the NTN may focus on Frequency Division Duplex (FDD), while Time Division Duplex (TDD) may be applied for relevant scenarios e.g., HAPS, ATG, and the NTN may cover or have Earth fixed tracking area, In the NTN, the wireless devices, such as UEs, can have GNSS capabilities, have transparent payload. Furthermore, the NTN can support or cover any appropriate devices, such as Handheld devices in FR1 (e.g., power class 3), “VSAT” devices with external antenna at least in FR2 (RAN1-3 specifications), and so on.

In wireless communication via NTNs, an NTN cell will cover a wider radio cells, where the NTN cell may mean a cell covered or served by a spacecraft or aircraft, such as a satellite. More specifically, in NTN, the coverage of a cell or a beam for the cell is typically much larger than the cell in the terrestrial networks, and the coverage of one NTN cell may even across multiple countries.

A Handover (also be referred to as HO) belongs to a kind of operation frequently occurring in the wireless communication that when a cell in which a user terminal is located or a network device serving the user terminal is intended to change, the user terminal would disconnect with the previous network device (referred to as a source network device) and then connect to a new network device (referred to as a target network device). Such Handover operation can be performed in a variety of manners. In an example, the user terminal moves from a cell (referred to as source cell) to a new cell (referred to as a target cell), and to continue to perform wireless communication, the user terminal needs to disconnect with the source cell or related network device and then switch to the target cell to connect with the target network device. In another example, the network device may have a coverage including a huge amount of wireless devices, such as in a NTN, and the network device, such as a satellite, may move so that even the user terminal does not move, the network device serving the user terminal may change, which also means the cell serving the user terminal changes, and thus when a new network device move to cover the wireless devices, the wireless device will perform the Handover operation to disconnect with the previous network device and then connect to the new wireless device.

In the wireless communication system, Handover can be implemented in any appropriate handover frames, such as an appropriate Legacy handover mechanism, in which the user terminal will perform the Handover upon receipt of Handover common from the network device. Such Legacy handover mechanism will be supported with some restrictions. For example, UE is not required to connect to both an NTN and TN cell simultaneously during handovers, and/or DAPS (Dual Active Protocol Stack) is not supported.

Furthermore, Handover can be implemented in Conditional Handover (also be referred to as CHO) mechanism, in which the user terminal can perform the Handover when the user terminal judges the Handover condition is met based on a measurement result. In particular, conditional Handover conditions are introduced for NTN specific CHO due to the NTN radio characteristics. More specifically, NTN specific characteristics may include that the variation in signal strength/quality between cell-center and cell-edge is not so pronounced, as shown in FIG. 3B. NTN specific CHO conditions may include any appropriate condition, such as condEventA4, condEventT1, condEventD1, etc., as shown in the following Table 1. Wherein EventD1 can be configured as the normal measurement event for measurement report. Note that condEventT1 and condEventD1 is always configured together with one of the measurement-based trigger conditions (CHO events A3/A4/A5).

TABLE 1

| NTN CHO | |
|---|---|
| condition | Description |
| condEventA4 | Measurement event A4 (i.e. Neighbour becomes |
| | better than threshold) |
| condEventT1 | Time-based trigger condition |
| | CHO can be executed only between T1 and T2 |
| | NW configures T1 (i.e. t1-Threshold) and |
| | duration (duration) using UTC time |
| condEventD1 | Location-based trigger condition |
| | CHO can be executed when the following |
| | two conditions are fulfilled |
| | Distance between UE and a referenceLocation1 > |
| | distanceThreshFromReference1; (away from PCell) |
| | Distance between UE and a referenceLocation2 < |
| | distanceThreshFromReference2; (close to candidate cell) |

CHO recovery can be executed in a variety of manners. More specifically, for the candidate cell with condEventT1, CHO recovery cannot be executed if timer T2 has not expired, and for the candidate cell with condEventD1, CHO recovery can be excluded without checking condEventD1.

The NTN specific scenario may include a variety of scenarios. In particular, in a LEO scenario, the cell is moving together with the satellite, and all the UEs in the geographic area have to perform the handover due to the satellite change. In a feeder link switching case, the cell served by the satellite will change, and all the UEs served by the satellite have to perform the handover due to the cell information change, even though the service link is no change. For example, FIG. 3C illustrates exemplary transitions of UEs as a cell moves completely out of original coverage area.

However, the NTN specific handover may have issues. More specifically, considering the large cell size of non-terrestrial networks, huge amounts of devices may be served within a single cell. Depending on constellation assumptions (e.g., propagation delay and satellite speed) and UE density, a potentially very large number of UEs may need to perform HO at a given time, leading to possibly large signaling overhead and service continuity challenges. In particular, the cell congestion due to the UE handover, particularly group UE handover, may be introduced, and shall be avoided.

Therefore, it is still desirable to improve Handover operation, particularly distribute the Handover load in order to mitigate the HO congestion. In particular, the present disclosure proposes an improved Handover solution. In particular, for UEs in a source cell intended to perform a handover to a target cell, their HO operations can be dispersedly executed, instead of being executed intensively, and thus Handover load congestion can be mitigated.

Specifically, the present disclosure proposes a novel delay configuration for the Handover operation, and particularly, at least one of UEs can be configured with delay time for the HO operation, so that the UE can delay its corresponding Handover. That is, for each of the at least one UE, an appropriate delay time can be configured accordingly, and thus the UE can perform the HO after such an appropriate delay time since the HO execution condition is met.

Compared with the case in the prior art that a plurality of UEs need to perform HO at a given time conventionally, in the present disclosure, at least one UE can delay execution of its corresponding HO operation, and thus the HO operations of UEs can be executed dispersedly at different times since the HO execution condition is met, instead of being concentrated on a specific time or a specific time period. Therefore, the HO operations to be executed by UEs can be distributed, and thus HO loads can be distributed, and the cell congestion due to the group UE handover may be avoided and the system overhead can be reduced or alleviated.

Various embodiments according to the present disclosure will be described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component of the wireless device, or the wireless device. Additionally, various embodiments according to the present disclosure will be described with regard to a gNB. However, reference to a gNB is merely provided for illustrative purposes. The example embodiments may be utilized with any electronic component that may establish a connection to a wireless device and is configured with the hardware, software, and/or firmware to exchange information and data with the wireless device. Therefore, the gNB as described herein is used to represent any appropriate electronic component of the network device, or the network device.

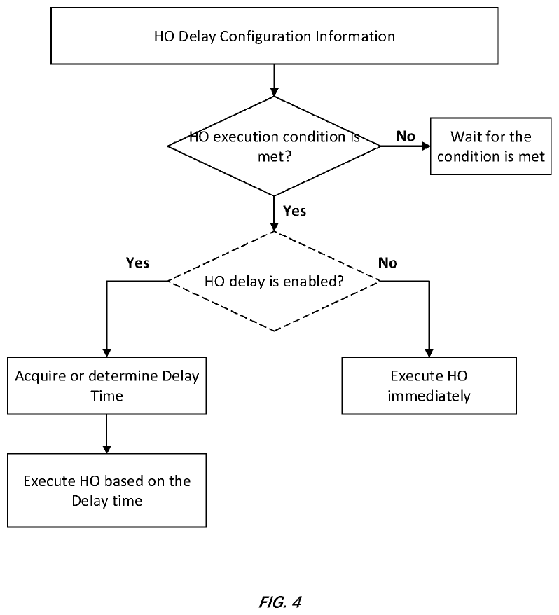

FIG. 4 illustrates a conceptual diagram of the Handover operation according to some embodiments of the present disclosure. In particular, when a HO execution condition is met, UEs in a cell (also be referred to as a source cell) can be ready to perform the Handover operation, which may relate to Handover from the source cell to a target cell. Note that the source cell may mean the cell in which UEs are located before such HO, such as due to a satellite change in the NTN, while the targe cell may mean the cell in which UEs will belong to after such HO. For example, the source cell and the target cell may be different cells, or may be the same cell covered by different satellites.

Then, for each of UEs in the source cell, it can be determined whether the UE can delay its corresponding Handover operation. Such determination can be based on information provided from the network device to the UE, such as delay enabling information or any other information for determining whether the delay is enabled from the network device or any other appropriate devices in the system. Whether the UE can delay its corresponding Handover operation can be notified by the network side or can be determined by the UE per se, which will be described hereinafter.

When it is determined a UE would not delay its Handover operation, the UE would begin to perform the Handover operation immediately when the HO execution condition is met.

On the other hand, when it is determined such a UE can delay its Handover operation, the UE would not perform the Handover operation until the delay time passes. That is, UE would perform the Handover operation after such a delay time. The delay time can be preconfigured by the network device and presented to the wireless device, or can be configured by the wireless device per se, which will be described hereinafter.

Note that the above concept process of the Handover operation according to the present disclosure is only exemplary, and it can be implemented in any other appropriate manner. In particular, determination or acquisition of information about whether the UE can delay its Handover operation or not, and/or the determination or acquisition of delay time information, can be performed in different order, and for example, such determination or acquisition can be performed in advance, particularly before the HO execution conditions are met, such as during initialization of the system, and then when the HO execution conditions are met, the UE can perform the Handover operation based on the pre-determined or pre-acquired delay configuration.

Hereinafter, the solution of the present disclosure will be described by taking NTN HO scenario as an example. Note that the solution of the present disclosure can be applied to any appropriate HO scenarios, including but not limited to NTN-to-NTN HO scenarios, NTN to TN HO scenarios, TN to NTN HO scenarios, TN to TN HO scenarios, etc., and similar improvement can be achieved.

FIG. 5 illustrates a flowchart illustrating an example method at the wireless device side at least according to some embodiments. Aspects of the method of FIG. 5 may be implemented by a wireless device such as a UE 106 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 5 may operate as follows.

At step 502, the wireless device acquires a delay configuration information about a Handover to be performed by the wireless device.

At step 504, the wireless device performs the Handover based on the delay configuration information when a Handover execution condition is met. In particular, when a Handover execution condition is met, the wireless device will perform the Handover operation in accordance with delay configuration indicated by the configuration information, such as, whether to delay the HO, how to delay the HO, and so on.

Thus, the method of FIG. 5 may be used by a wireless device to perform improved Handover, at least according to some embodiments.

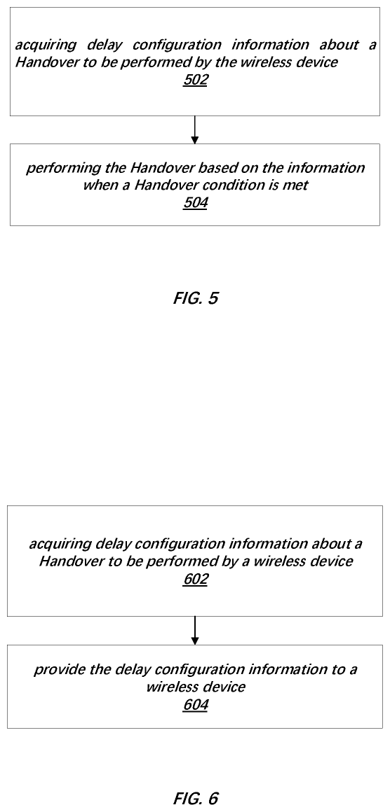

FIG. 6 illustrates a flowchart illustrating an example method at the network device side at least according to some embodiments. Aspects of the method of FIG. 6 may be implemented by a network-side device for example a base station such as a BS 102 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 6 may operate as follows.

At 602, the network-side device may acquire delay configuration information about a Handover to be performed by a wireless device.

At 604, the network-side device may provide the delay configuration information to the wireless device, so that the wireless device performs the Handover based on the delay configuration information when a Handover execution condition is met.

Thus, the method of FIG. 6 may be used by a network-side device, such as a base station, to schedule an improved Handover operation, at least according to some embodiments.

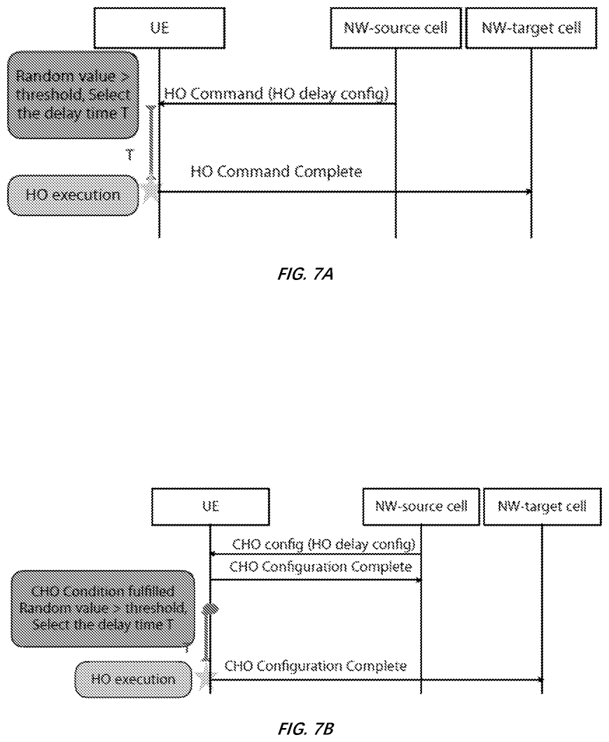

FIGS. 7A-10D illustrate further aspects that might be used in conjunction with the method of FIGS. 5 and 6 if desired. It should be noted, however, that the exemplary details illustrated in and described with respect to FIGS. 7A-10D are not intended to limit the disclosure as a whole: numerous variations and alternatives to the details provided herein below are possible and should be considered within the scope of the disclosure.

According to some embodiments of the present disclosure, the delay configuration information may include a delay enabling information indicating whether the Handover is enabled to be delayed. In particular, when the delay enabling information indicates the Handover can be delayed, the wireless device can delay its HO execution when the Handover execution condition is met, or else the wireless device would execute its HO immediately when the Handover execution condition is met.

In some embodiments, such delay enabling information can be in any appropriate format. For example, the information may be a binary value, wherein “1” may indicate the Handover operation is intended to be delayed, while “0” may indicate the Handover operation will not be delayed, and the Handover operation will be executed immediately when the Handover execution condition is met. Note that the information can be any other appropriate format, such as value, number, symbol, etc., as long as different value can be utilized to indicate whether the Handover operation is intended to be delayed.

According to some embodiments of the present disclosure, the delay enabling information can be generated or configured by the network device, and then provided to the wireless device. Note that the delay enabling information can be generated by the source network device and then provided to the wireless device, or can be generated by the target network device, and then presented to the source network device so as to provide to the wireless device, or can be generated by any other appropriate device in the system and then provided to the wireless device.

In some embodiments, such delay enabling information can be randomly set for the UEs. In an example, the network device can select the UEs whose HO can be delayed from the UEs in the cell randomly, and then present the selection result to the UEs in the cell, such as via propagation or other appropriate signaling.

In some other embodiments, for each of UEs in the cell, the network device can configure or set whether such a UE is allowed to delay its HO, such as based on data specific to UE, and then the network device provide the configuration result to the wireless device. Such specific data can be specifically configured or set for the UEs, for example, can generated by UE or can obtained from any other appropriate device in the wireless communication system in advance, and the threshold can be set by the network device, or can be obtained from any other appropriate device in the wireless communication system. For example, the UE's specific data is compared with the threshold, and when it is judged that the UE's specific data is larger than or equal to the threshold, determine the Handover of UE can be delayed.

In some embodiments, the UE's specific data can include a random value, which can be configured or random generated in a variety of manners, such as any random function. In an example, such random value may mean a probability that the UE can delay the Handover operation and can be configured or set in a predetermined range, such as [0, 1]. In some embodiments, the threshold can be configured by the network device in a variety of manners, such as in consideration of the performance of Handover operation, related to Handover delay, etc., In an example, such threshold may relate to the percentage of the UEs covered by the network device which are allowed to delay the Handover operation. More specifically, such threshold can be configured by the network device and then provided to the wireless device.

In some embodiments, at least one of such random value and threshold can be set in any appropriate time. In some embodiments, at least one of the random value and threshold can be configured and stored in advance, before the Handover execution condition is met. In some embodiments, at least one of the random value and threshold can be configured or set when the Handover execution condition is met. So that after the Handover execution condition is met, such random value and threshold can be utilized to determine whether the Handover operation is to be delayed.

According to some embodiments of the present disclosure, the wireless device per se can determine or judge whether the HO is allowed to be delayed, which can be equivalent to acquire the delay enabling information to some extent.

In some embodiments, the wireless device can determine whether the HO is allowed to be delayed based on UE's specific data with a threshold, similarly with that discussed above. For example, the wireless device can compare a UE selected random value as the UE's specific data with a preconfigured threshold, to decide whether to delay the HO. If the random value >=threshold, UE will delay the HO, and else, UE will perform the HO immediately.

In some embodiments of the present disclosure, whether Handover operation is intended to be delayed for a UE can be determined or set at any appropriate time. In particular, whether Handover operation is intended to be delayed can be preconfigured or preset for the UE, such as before the Handover execution condition is met, or can be configured or determined when the Handover execution condition is met.

Note that such delay enabling information indicating whether the Handover operation will be delayed is optional. In an example, if such information is not included, it may mean that all UEs can allowed to delay the Handover operation, and thus the UEs will delay the Handover operation appropriately when the Handover execution condition is met.

According to some embodiments of the present disclosure, whether Handover execution condition is met can be represented or indicated in a variety of manners.

In some embodiments, whether the Handover condition is met can be indicated by whether a Handover command is received by the wireless device. More specifically, when the wireless device receives a Handover command, particularly a command to execute Handover, such as from the network device, or any other appropriate device in the wireless communication system, it means the Handover execution condition is met, and the UE can perform the Handover operation, immediately or with delay. Such a case may correspond to a legacy HO framework, wherein the UE performs the Handover operation upon control or instruction of the network device. FIG. 7A illustrates an exemplary diagram showing such HO framework.

In some embodiment, whether the conditional Handover condition is met can be judged by wireless device. In particular, the wireless device judges whether some conditions related to Handover, particularly conditions related to conditional Handover (CHO), can be satisfied, and when the wireless device determines such conditions are met, it can be determined that a Handover execution condition is met, and the Handover operation can be executed immediately or with delay. Such case may correspond to a Conditional Handover framework, wherein the wireless device per se determine and execute the Handover operation. FIG. 7B illustrates an exemplary diagram showing such HO framework. Such determination of CHO condition can be implemented in any appropriate manner well known in the art, such as performing measurement and making determination based on the measurement result, and will not be described herein.

Alternatively, whether the conditional Handover condition is met can be judged by network device, or any other appropriate device in the wireless communication system and notified to the wireless device. In particular, only when the conditional Handover condition is met, the information indicting the Handover condition is met can be provided to the wireless device.

According to some embodiments of the present disclosure, the delay configuration information may include a delay time with which the Handover to be delayed, and the wireless device can be further configured to perform the Handover after the delay time since the Handover condition is met. In particular, such a delay time can be configured for at least one of UEs in the source cell, so that such at least one UE can perform its Handover after the configured delay time since the Handover execution condition is met.

In some embodiments of the present disclosure, the delay time may mean a time which is delayed with reference to a reference time, and such reference time corresponds to the time when the Handover execution condition is met and at which the Handover is usually executed in the prior art.

According to some embodiments of the present disclosure, the information about the delay time can be expressed in a variety of manners. In one embodiment, the information may indicate a time difference, that is, the time difference from the original time. In another embodiment, the information may be an index, which may indicate a discrete time difference, that is, the time difference from the original time. In yet another embodiment of the present disclosure, the information may be a time value indicating the time at which the HO operation is intended to be executed, and which can be derived from the original time.

According to some embodiments, such a delay time can be configured or set in a variety of manners. In some embodiments, the delay time can be determined randomly. In particular, the delay time can be selected from a set of discrete delay times randomly, or can be determined within a duration randomly.

In one embodiment, the delay time can be determined or selected in a duration in a random way, and particularly by means of a random function. Such a random function can be implemented in a variety of manners well known in the art, which will not be described herein. In some embodiments, the duration can be preset, such as preset empirically. In some embodiments, the duration can set by the network device, or any other appropriate device in the wireless communication system. In some embodiments, the duration can be pre-set, such as during initialization of the system, before the HO, or can be set when the HO execution condition is met.

For example, the random value T can be selected within a duration X, and the random value T can be a value which is smaller than or equal to the duration X. In another example, the duration can also be set as [X1, X2], X1, X2 can be set to non-zero, and the duration can be a value which is between the X1 and X2, including X1 and X2.

In some embodiments, the delay time can be selected from a set of delay times, such as a set of discrete candidate times, a list of delay times. In some other embodiments, such delay time can be randomly selected from the set of candidate times. And such set of candidate times can be configured by the network device and presented to the wireless device. In some embodiments, such set of candidate times can be pre-set, such as during initialization of the system, before the HO, or can be set when the HO execution condition is met.

For example, a value T can be selected randomly from a set of candidate delay values [T1, T2, T3], T1, T2, T3 can be set to non-zero, and particularly, the value T can be any of T1, T2, T3, in a random way. Note that the number of candidate delay values is not limited to three, and can be any other appropriate number, which can be preset, preconfigured or set.

According to some embodiments of the present disclosure, additionally or alternatively, the delay time can be configured or set based on at least one of factors selected from a group comprising characteristics of the wireless device or characteristics of Handover. In particular, the characteristic of the wireless device may include at least one of service type, power situation, mobility state, device type of the wireless device. In another example, the characteristic of Handover may comprise the type of Handover. In some embodiments of the present application, the delay time is determined based on the characteristics values of the wireless device when the Handover execution condition is met.

In some embodiments of the present application, for a factor, different delay times are set for different values or states of the factor. Therefore, when to configure or set the delay time, the value or state of the factor is judged and then a delay time corresponding to the judged value or state of the factor can be configured or set. More specifically, for a kind of characteristic of the wireless device, the value or state of the characteristic of the wireless device can be determined or acquired when the HO execution condition is met, and then a delay time can be configured or set corresponding to the determined or configured value or state of the characteristic.

For example, mobility state of UE can serve as an example of the characteristic of the UE for configuring the delay time, and the mobility state of UE can be classified as a HIGH mobility state and a LOW mobility state, and each of HIGH mobility state and a LOW mobility state can be configured with corresponding delay values T1 and T2. Then, when the delay time for UE is to be determined, the mobility state can be judged and when it is judged that UE is in HIGH mobility state, the delay time for UE is T1, or when it is judged that UE is in LOW mobility state, the delay time for UE is T2. Note that the classification of characteristic of the wireless device is not so limited, and the characteristic of the wireless device can be classified into more or less classes, and for each class, corresponding delay value can be preconfigured.

According to some embodiments of the present application, the delay time can be determined or set in any appropriate manner, such as deterministically or randomly.

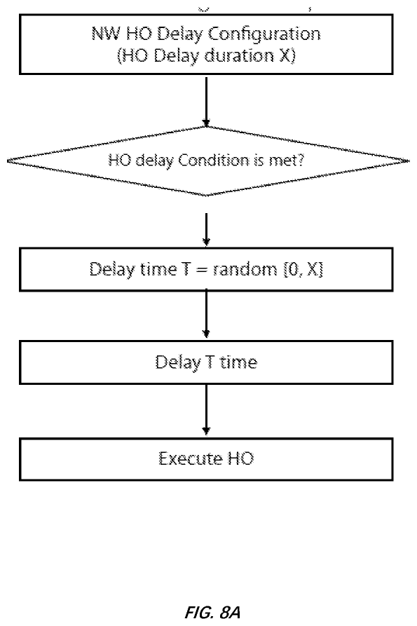

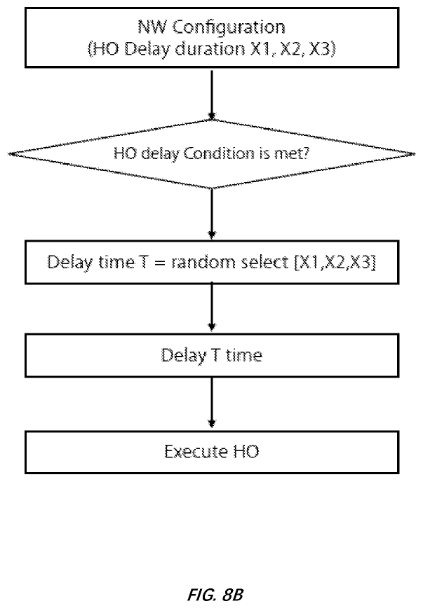

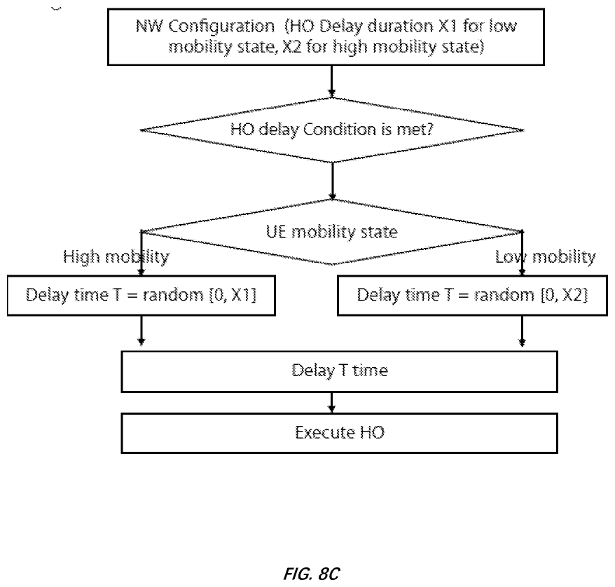

In one embodiment, for a value or state of the characteristic of the wireless device, its corresponding delay value can be a single value, for example, a single value is preconfigured or preset for a value or state or class of the characteristic, and when the delay time is to be determined, the value corresponding to the judged value or class of the characteristic can be selected, and thus be determined deterministically, as shown in FIG. 8C.

In another embodiment, for a value or state of the characteristic of the wireless device, its corresponding delay value can be determined or set randomly. In particular, the delay value for a value or state or class of the characteristic of the wireless device can be determined or set randomly in a way similar with that as discussed above. For example, for a value or state of the characteristic of the wireless device, a duration or a set of candidate delay values can be preconfigured, and then the delay value can be determined randomly therefrom.

Furthermore, the delay time can be configured or set based on the HO characteristics, which may include any of NTN-NTN HO, NTN-TN HO, TN-NTN HO, and so on. And similar with the above, for the HO characteristic, the delay time can be determined in any appropriate manner, such as deterministically or randomly.

According to some embodiments of the present disclosure, the delay time can be determined or set based on at least two factors, for example, at least two of service type, UE power situation, UE mobility state, UE device type, HO characteristic, etc., In particular, for each factor, a delay time corresponding to the factor may be determined, in a similar way with that discussed above, and then a whole delay time can be obtained by combining all determined delay times.

In some embodiments, such combination can be performed in a variety of manners. for example, the combination can relate to weighted combination of the determined delay times. And weights corresponding to each factor can be appropriately set, for example, in consideration of the priority of the sub-characteristics.

In some embodiments, the delay time can be determined by the wireless device, and in particular, the delay time can be configured or determined at the side of the wireless device, in a way similar with that as discussed above.

FIGS. 8A to 8C illustrates an exemplary determination and usage of the delay time at the wireless device side. In particular, the HO delay duration, for example, a single duration, a set or list of candidate delay time, a set or list of durations, durations corresponding to different values or classes of the factor, etc., can be provided by the network device to the wireless device, so that the wireless device can determine or configure the delay time based on the delay duration, as discussed above.

In some other embodiments, the delay time can be determined by the network device and provided to the wireless device, and particularly, the delay time can be configured or determined at the side of the network device, in a way similar with that as discussed above, and presented to the wireless device. In an example, the delay time can be generated by the source network device and provided to the wireless device. In another example, the delay time can be generated by the target network device and provided to the source network device, and in turn be provided to the wireless device. In some other embodiments of the present application, the delay time can be configured or determined by any appropriate device in the wireless communication system, in a way similar with that as discussed above, and presented to the wireless device.

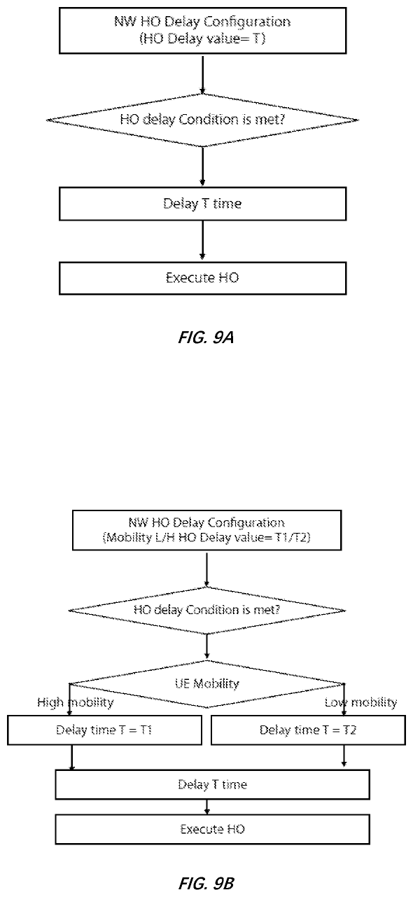

FIGS. 9A to 9B illustrates the case that the delay time are generated or configured at the network device side and provided to the wireless device. In particular, the HO delay time is generated or configured by the network device, in a manner similar with that as discussed above, and then be provided to the wireless device, so that the wireless device can utilize such delay time to perform HO.

In some embodiments, the network device can provide, via L1/L2/L3 dedicated signaling or common signaling, the delay configuration information, or other information related to determination of the delay time, such as the threshold for judging whether the delay is allowed to be executed, the duration from which the delay time can be randomly set, etc., as discussed above.

For example, NW can decide the HO delay configuration based on the cell level information, and inform the delay information to UE via an interface by L1/L2/L3 signaling. And the signaling can be provided to all the UEs, or a group of UEs, or a specific UE.

In some embodiments, the network device can provide, in HO command or CHO command, the delay configuration information, or other information related to determination of the delay time, such as the threshold for judging whether the delay is allowed to be executed, the duration from which the delay time can be randomly set, etc., as discussed above. For example, Source gNB can provide the HO delay configuration, as well we the information as discussed above, and deliver it together with the HO command to the UE. For CHO, source gNB can provide the HO delay configuration together with the CHO condition and carry it in the CHO command.

In some embodiments, the network device can provide, in system information block (also be referred to as SIB,) the delay configuration information, or other information related to determination of the delay time, such as the threshold for judging whether the delay is allowed to be executed, the duration from which the delay time can be randomly set, etc., as discussed above. For example, UE can use the configuration of the serving cell's SIB to decide the HO delay time.

In some embodiments, the network device, which may present or provide the delay configuration information or other information, may be the network device in the source cell, can be referred to as source network device. In particular, the network device can obtain the delay configuration information or other information from a network device in the target cell, also be referred to as target network device, and then provide the information to the wireless device.

For example, Target gNB provide the HO delay configuration together with other configuration to source gNB, and source gNB include it in the HO command and transmit it to UE. Target gNB provision of the HO delay configuration can based on the source gNB information or upon request.

According to some embodiments of the present application, the wireless device can perform the Handover operation based on the delay time. In particular, the wireless device can perform the Handover operation after the delay time since the HO execution condition is met.

In some embodiments, the wireless device may be configured with a timer indicating the delay time, and when the Handover condition is met, the time begins to work and when the timer expires, which may mean the delay time is delayed from the time when the Handover execution condition is met, then the wireless device can begin to perform the Handover operation to try to connect to a new network device.

According to some embodiments of the present application, the wireless device can perform the Handover operation based on the delay time in a variety of manners.

In some embodiments, the wireless device can execute the Handover operation immediately after the delay time expires. For example, since the Handover execution condition is met, once the delay time expires, the Handover operation will be executed immediately, that is, the Handover operation starts the execution of HO from the beginning.

In some embodiments, additionally, the wireless device can perform a synchronization operation and then when the synchronization is implemented and the delay time expires, the wireless device can perform the Handover operation to try to connect to a new wireless device.

More specifically, when the wireless device changes, the synchronization between the wireless device and the network device may be influenced, even lost. Therefore, to ensure the connection between the wireless device and the network device, it is preferable to perform the synchronization operation before the Handover operation. Such synchronization can be a kind of Downlink synchronization. More specifically, the synchronization operation can belong to the first Uplink transmission from the wireless device to the network device.

Furthermore, the first Uplink transmission can mean an uplink transmission from the wireless device to the new network device, and may further include a kind of pre-compensation, particularly NTN specific TA pre-compensation. More specifically, during Handover operation, the wireless device can transfer to a new cell. In one example, even if the wireless device does not move, since the wireless device moves, and the wireless device will be covered by a new network device, which can be deemed as the wireless device will belong to a new cell, will be deemed as a target cell.

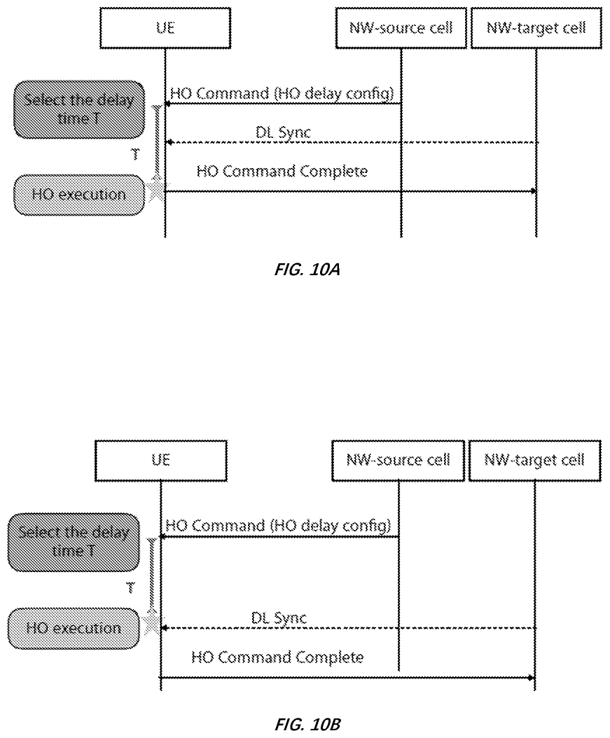

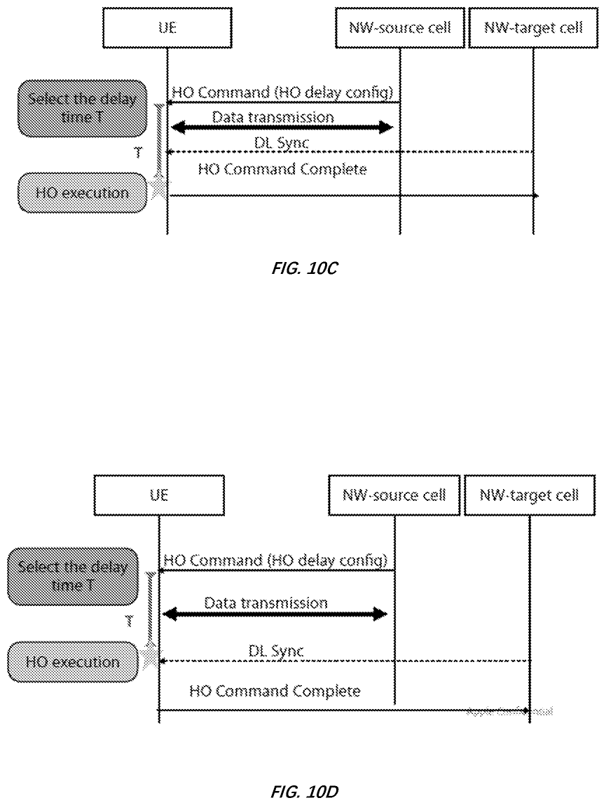

According to some embodiments of the present application, such synchronization operation can be performed during the delay time. More specifically, during the delay time period, the synchronization can be performed, as shown in FIG. 10A.

According to some embodiments of the present application, such synchronization operation can be performed when the delay time expires, as shown in FIG. 10B.

According to some embodiments of the present disclosure, the wireless device can further perform data transmission during the delay time. In particular, the wireless device can perform data transmission in the source cell. That is, the data transmission between the wireless device and the current or previous or original network device will be kept, instead of the new or subsequent or target network device.

In some embodiments, the data transmission in source cell can be kept during the HO delay time, and can be combined with the synchronization process during the HO delay time or after the HO delay time, as shown in FIGS. 10C and 10D.

Embodiments contemplated herein include an apparatus comprising means to perform one or more elements of the method for Handover operation distribution at the wireless device side. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method at the wireless device side according to some embodiments of the present disclosure. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method at the wireless device side according to some embodiments of the present disclosure. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method at the wireless device side according to some embodiments of the present disclosure. This apparatus may be, for example, an apparatus of a UE (such as a wireless device 202 that is a UE, as described herein).

Embodiments contemplated herein include a signal as described in or related to one or more elements of the method at the wireless device side according to some embodiments of the present disclosure.

Embodiments contemplated herein include a computer program or computer program product comprising instructions, wherein execution of the program by a processor is to cause the processor to carry out one or more elements of the method at the wireless device side according to some embodiments of the present disclosure. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method at the network device according to embodiments of the present disclosure. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method at the network device according to embodiments of the present disclosure. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method at the network device according to embodiments of the present disclosure. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method at the network device according to embodiments of the present disclosure. This apparatus may be, for example, an apparatus of a base station (such as a network device 218 that is a base station, as described herein).

Embodiments contemplated herein include a signal as described in or related to one or more elements of the method at the network device according to embodiments of the present disclosure.

Embodiments contemplated herein include a computer program or computer program product comprising instructions, wherein execution of the program by a processing element is to cause the processing element to carry out one or more elements of the method at the network device according to embodiments of the present disclosure. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

In the following further exemplary embodiments are provided.

One set of embodiments may include a wireless device, comprising: at least one antenna; at least one radio coupled to the at least one antenna; and a processor coupled to the at least one radio; wherein the wireless device is configured to: acquire delay configuration information about a Handover to be performed by the wireless device; and perform the Handover based on the information when a Handover execution condition is met.

According to some embodiments, the delay configuration information includes a delay enabling information indicating whether the Handover is enabled to be delayed.

According to some embodiments, the delay enabling information is generated by the network device in a random way and provided to the wireless device.

According to some embodiments, the wireless device is further configured to: acquire a random value and a preconfigured threshold related to Handover delay, compare the random value with a threshold, and when it is judged that the random value is larger than or equal to the threshold, determine the Handover cab be delayed.

According to some embodiments, the random value is generated by the wireless device, and the threshold is preconfigured by the network device and provided to the wireless device.

According to some embodiments, when a Handover command is received by the wireless device or the wireless device determines a conditional Handover (CHO) condition is met, the Handover execution condition is met.

According to some embodiments, the delay configuration information includes a delay time with which the Handover to be delayed, and the wireless device is further configured to: perform the Handover after the delay time since the Handover condition is met.

According to some embodiments, the delay time is determined randomly.

According to some embodiments, the delay time is selected from a set of discrete delay times randomly or determined within a duration randomly.

According to some embodiments, the delay time is determined based on at least one of factors selected from a group comprising characteristics of the wireless device or characteristics of Handover.

According to some embodiments, the delay time is determined based on the characteristics of the wireless device when the Handover condition is met.

According to some embodiments, the delay time is determined by combining delay times corresponding to at least two factors.

According to some embodiments, the characteristic of the wireless device includes at least one of service type, power situation, mobility state, device type of the wireless device.

According to some embodiments, the characteristic of Handover comprises the type of Handover.

According to some embodiments, the delay time is determined by the wireless device or is determined by the network device and provided to the wireless device.

According to some embodiments, the wireless device is further configured to: preform data transmission to a source network device of the Handover during the delay time.

According to some embodiments, the wireless device is further configured to: perform synchronization process to a target network device of the Handover during the delay time or after the delay time.

Another set of embodiments may include a network device, comprising at least one antenna; at least one radio coupled to the at least one antenna; and a processor coupled to the at least one radio; wherein the network device is configured to: acquire delay configuration information about a Handover to be performed by a wireless device; and provide the delay configuration information to the wireless device.

According to some embodiments, the network device provides the delay configuration information to the wireless device via at least one of a Handover command, SIB, L1, L2 or L3 signaling.

According to some embodiments, the network device services as a source network device of the Handover, and acquires the delay configuration information from a target network device of the Handover.

Yet another set of embodiments may include an apparatus, comprising: a processor configured to cause a wireless device to: acquire delay configuration information about a Handover to be performed by the wireless device; and perform the Handover based on the information when a Handover condition is met.

Yet another set of embodiments may include an apparatus, comprising: a processor configured to cause a network device to: acquire delay configuration information about a Handover to be performed by a wireless device; and provide the delay configuration information to the wireless device.

Yet another set of embodiments may include a method for a wireless device, comprising: acquiring delay configuration information about a Handover to be performed by the wireless device; and performing the Handover based on the information when a Handover condition is met.

Yet another set of embodiments may include a method for a network device, comprising: acquiring delay configuration information about a Handover to be performed by a wireless device; and providing the delay configuration information to the wireless device.

Yet another set of embodiments may include a device comprising: a processor, and a computer-readable storage medium, having program instructions stored thereon, which, when executed, cause the processor to implement any or all parts of any of the preceding method embodiments.

Yet another set of embodiments may include a computer-readable storage medium, having program instructions stored thereon, which, when executed, cause the processor to perform any or all parts of any of the preceding method embodiments.

Yet another set of embodiments may include a computer program product comprising program instructions, which, when executed by a computer, cause a computer to perform any or all parts of any of the preceding method embodiments.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A wireless device, comprising:
at least one antenna;
at least one radio coupled to the at least one antenna; and
a processor coupled to the at least one radio;
wherein the processor is configured to:
acquire delay configuration information about a Handover to be performed by the wireless device; and
perform the Handover based on the information when a Handover execution condition is met.

2. The wireless device of claim 1, wherein the delay configuration information includes a delay enabling information indicating whether the Handover is enabled to be delayed.

3. The wireless device of claim 2, wherein the delay enabling information is generated by the network device in a random way and provided to the wireless device.

4. The wireless device of claim 1, wherein the processor is further configured to:
acquire a random value and a preconfigured threshold related to Handover delay,
compare the random value with a threshold, and
when it is judged that the random value is larger than or equal to the threshold, determine the Handover cab be delayed.

5. The wireless device of claim 1, wherein when a Handover command is received by the wireless device or the wireless device determines a conditional Handover (CHO) condition is met, the Handover execution condition is met.

6. The wireless device of claim 1, wherein the delay configuration information includes a delay time with which the Handover to be delayed, and the processor is further configured to:
perform the Handover after the delay time since the Handover condition is met.

7. The wireless device of claim 6, wherein the delay time is selected from a set of discrete delay times randomly or determined within a duration randomly.

8. The wireless device of claim 6, wherein the delay time is determined based on at least one of factors selected from a group comprising characteristics of the wireless device or characteristics of Handover.

9. The wireless device of claim 8, wherein the delay time is determined by combining delay times corresponding to at least two factors.

10. The wireless device of claim 8, wherein the characteristic of the wireless device includes at least one of service type, power situation, mobility state, device type of the wireless device, and/or, wherein the characteristic of Handover comprises the type of Handover.

11. The wireless device of claim 1, wherein the processor is further configured to:
preform data transmission to a source network device of the Handover during the delay time, and/or
perform synchronization process to a target network device of the Handover during the delay time or after the delay time.

12. A network device, comprising:
at least one antenna;
at least one radio coupled to the at least one antenna; and
a processor coupled to the at least one radio;
wherein the processor is configured to:
acquire delay configuration information about a Handover to be performed by a wireless device; and
provide the delay configuration information to the wireless device.

13. The network device of claim 12, wherein the network device provides the delay configuration information to the wireless device via at least one of a Handover command, SIB, L1, L2 or L3 signaling.

14. The network device of claim 12, wherein the network device services as a source network device of the Handover, and acquires the delay configuration information from a target network device of the Handover.

15. An apparatus, comprising:
a processor configured to cause a wireless device to:
acquire delay configuration information about a Handover to be performed by the wireless device; and
perform the Handover based on the information when a Handover condition is met.

16-21. (canceled)

22. The apparatus of claim 15, wherein the delay configuration information includes a delay enabling information indicating whether the Handover is enabled to be delayed.

23. The apparatus of claim 22, wherein the delay enabling information is generated by the network device in a random way and provided to the wireless device.

24. The apparatus of claim 15, wherein the processor is further configured to:
acquire a random value and a preconfigured threshold related to Handover delay,
compare the random value with a threshold, and
when it is judged that the random value is larger than or equal to the threshold, determine the Handover cab be delayed.

25. The apparatus of claim 15, wherein when a Handover command is received by the wireless device or the wireless device determines a conditional Handover (CHO) condition is met, the Handover execution condition is met.

26. The apparatus of claim 15, wherein the delay configuration information includes a delay time with which the Handover to be delayed, and the processor is further configured to:
perform the Handover after the delay time since the Handover condition is met.
